(19) United States
(12) Patent Application Publication
(10) Pub. No.: US 2025/0007287 A1
(43) Pub. Date: Jan. 2, 2025

(54) MANAGEMENT DEVICE, MANAGEMENT METHOD, AND STORAGE MEDIUM

(71) Applicant: HONDA MOTOR CO., LTD., Tokyo (JP)

(72) Inventors: Takayuki ENOMOTO, Wako-shi (JP); Yasuhiro NAKADA, Wako-shi (JP); Kenji SHIBATA, Wako-shi (JP); Miho TOKUNAGA, Wako-shi (JP); Ryuichi KIMATA, Tokyo (JP)

(21) Appl. No.: 18/830,818

(22) Filed: Sep. 11, 2024

Related U.S. Application Data
(63) Continuation of application No. PCT/JP2022/011690, filed on Mar. 15, 2022.

(51) Int. Cl. H02J 3/14; H02J 13/00

(52) U.S. Cl. CPC H02J 3/144; H02J 13/00002; H02J 13/00006

(57) ABSTRACT

A management device controls an interruption unit provided between a power supply source and each of a plurality of outlets. The device determines whether it is in a supply shortage state, determines priorities of the plurality of outlets, and switches the interruption unit associated with an outlet having a low priority to a disconnection state in a case of a supply shortage state. Each of the plurality of outlets includes an acquisition unit configured to acquire priority identification information from a storage medium to which the priority identification information is assigned when at least one load is connected. The device determines the priority of the outlet for each of the plurality of outlets based on the priority identification information acquired by the acquisition unit.

### CROSS-REFERENCE TO RELATED APPLICATION(S)

This application is a continuation of International Patent Application No. PCT/JP2022/011690 filed on Mar. 15, 2022, the entire disclosures of which are incorporated herein by reference.

### BACKGROUND OF THE INVENTION

### Field of the Invention

The present invention relates to a power supply technology in an off-grid or a microgrid.

### Description of the Related Art

In recent years, an off-grid power supply system has been adopted for power demand in non-electrified areas and during disasters. In such an off-grid power supply system, power is supplied not from a large-scale power generation facility such as a power plant but from a power supply source such as solar power generation, engine power generation, or a battery connected to the system. Therefore, since power that can be covered by the power supply system depends on a power generation capacity of the connected power supply source, it is necessary to control a power supply status in a case where the power generation capacity decreases or when power consumption exceeds the power generation capacity in order to stably operate the power supply system.

Japanese Patent Laid-Open No. 2016-535972 discloses a method of controlling whether or not to allow energy consumption based on a characteristic (application) of an electric device connected to a grid or a subgrid in a case where there is a demand in a situation where energy that can be provided is low.

By the way, in the method of Japanese Patent Laid-Open No. 2016-535972, a load (a device or the like) connected to an outlet is identified, and it is determined whether or not to permit power consumption according to the application, so that there has been a possibility that it will not necessarily meet a demand of a demander. That is, in a case where it is determined that an application of a load desired to be used by the demander is a low-priority application, the load cannot be used in some cases.

### SUMMARY OF THE INVENTION

The present invention implements stable power supply while reflecting a demand of a demander in a power supply system having a restriction on supplied power.

The present invention in its first aspect provides a management device configured to control an interruption unit provided between a power supply source and each of a plurality of outlets, the management device comprising: a monitoring unit configured to determine whether or not it is in a supply shortage state based on a difference between supplied power from the power supply source and power consumption of at least one load connected to each of the plurality of outlets; a determination unit configured to determine priorities of the plurality of outlets; and a control unit configured to switch the interruption unit associated with an outlet having a low priority based on a determination result of the determination unit to a disconnection state in a case where the monitoring unit determines that it is in the supply shortage state, wherein each of the plurality of outlets includes a first acquisition unit configured to acquire priority identification information from a storage medium to which the priority identification information is assigned when the at least one load is connected, and the determination unit determines the priority of the outlet for each of the plurality of outlets based on the priority identification information acquired by the first acquisition unit.

The present invention in its second aspect provides a management method of controlling an interruption unit provided between a power supply source and each of a plurality of outlets, the management method being executed by a management device and comprising: judging whether or not it is in a supply shortage state based on a difference between supplied power from the power supply source and power consumption of at least one load connected to each of the plurality of outlets; determining priorities of the plurality of outlets; and switching the interruption unit associated with an outlet having a low priority based on a determination result in the determining to a disconnection state in a case where it is judged to be in the supply shortage state in the judging, wherein each of the plurality of outlets acquires priority identification information from a storage medium to which the priority identification information is assigned when the at least one load is connected, and in the determination, the priority of the outlet is determined for each of the plurality of outlets based on the acquired priority identification information.

The present invention in its third aspect provides a computer-readable storage medium storing a program for causing a computer configured to control an interruption unit provided between a power supply source and each of a plurality of outlets to execute: judging whether or not it is in a supply shortage state based on a difference between supplied power from the power supply source and power consumption of at least one load connected to each of the plurality of outlets; determining priorities of the plurality of outlets; and switching the interruption unit associated with an outlet having a low priority based on a determination result in the determining to a disconnection state in a case where it is judged to be in the supply shortage state in the judging, wherein each of the plurality of outlets acquires priority identification information from a storage medium to which the priority identification information is assigned when the at least one load is connected, and in the determination, the priority of the outlet is determined for each of the plurality of outlets based on the acquired priority identification information.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of a power supply system;

FIG. 2 is a block diagram illustrating a hardware configuration of a management device 100;

FIG. 3 is a block diagram illustrating a hardware configuration of a dwelling 300;

FIG. 4 is a diagram illustrating outlet information managed by an outlet DB 110;

FIG. 5 is a flowchart illustrating interruption control processing by the management device 100 of a first embodiment;

FIG. 6A is a diagram illustrating another method of setting a priority of an outlet; and

FIG. 6B is a diagram illustrating still another method of setting the priority of the outlet.

### DESCRIPTION OF THE EMBODIMENTS

### First Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In an embodiment described below, an example in which the present invention is applied to a management device capable of monitoring a power generation status of a power supply source and a power supply status for a plurality of dwellings used by demanders for an off-grid power supply system as an example of the management device will be described. However, the present invention is applicable to any device capable of monitoring supplied power supplied from a power supply source to a power supply system and power consumption of a load connected to an outlet belonging to the power supply system.

Furthermore, in the present specification, the “power supply source” is any device having a power supply function. For example, a typical power supply source in an off-grid power supply system includes a generator of any power generation system such as a solar power generation system, a wind power generation system, or an engine power generation system. A charged battery can also be used as the power supply source.

### <<Configuration of Power Supply System>>

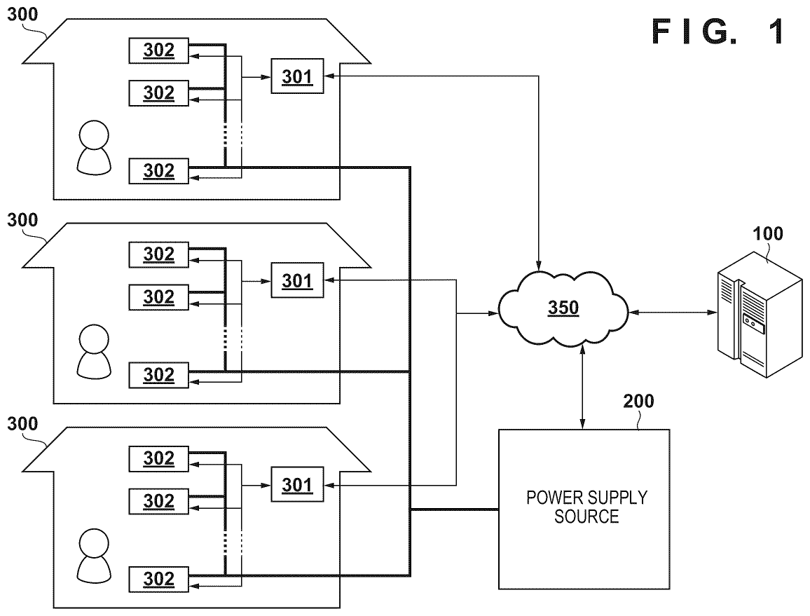

FIG. 1 is a diagram illustrating a configuration of a power supply system according to the present embodiment. As illustrated in the drawing, in the power supply system, power is supplied from a power supply source 200 to a plurality of dwellings 300 via a predetermined power line. One or more outlets 302 and an electronic control unit (ECU) 301 that acquires a power supply status for a load connected to each outlet 302 and switches whether or not to supply power to each outlet 302 are provided in each dwelling 300. A management device 100 manages power supply to all the outlets 302 belonging to the power supply system. In the power supply system, the management device 100, the power supply source 200, and a plurality of ECUs 301 are connected via a network 350 so as to be able to communicate.

In an arbitrary dwelling 300, when a load is connected to the outlet 302, the ECU 301 intermittently acquires the power supply status for the load. The ECU 301 transmits acquired information regarding the power supply status to the management device 100 together with information for identifying the outlet 302, and the management device 100 can acquire the power supply status for the outlet 302. In addition, a communication unit (not illustrated) that intermittently acquires information regarding power (supplied power) supplied to the power supply system as the power generation status is provided in the power supply source 200, and the management device 100 acquires the information regarding the supplied power from the communication unit.

Since the power supply system of the present embodiment is assumed to be an off-grid system that supplies power generated by the power supply source 200 to a small-scale area where about ten dwellings 300 are present, for example, a description will be given assuming that the network 350 is a local area network (LAN). However, in an aspect in which power is supplied to a wider area or in an aspect in which information is transmitted to an external server (not illustrated) or the like in order to calculate a power usage charge, for example, the network 350 may be a wide area network such as the Internet.

Hereinafter, a hardware configuration involved in implementation of the present invention will be further described with reference to the drawings.

### <Hardware Configuration of Management Device 100>

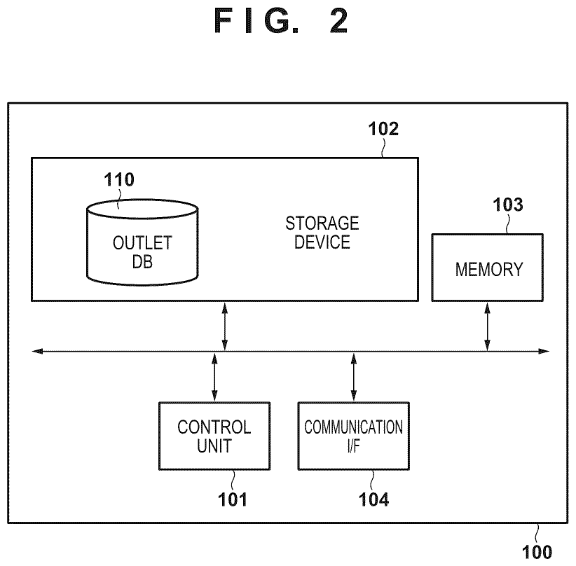

First, a hardware configuration of the management device 100 of the present embodiment will be described with reference to a block diagram of FIG. 2. A control unit 101 is a processor represented by a central processing unit (CPU), and implements operation control of each block and various functions to be described later by developing a program recorded in a storage device 102 in a memory 103 and executing the program. The storage device 102 is a nonvolatile storage device capable of permanently storing information, such as a read only memory (ROM) or a hard disk drive (HDD). Here, the program executed by the control unit 101 may be installed in the storage device 102 of the management device 100 via a storage medium such as a CD-ROM. The memory 103 is a volatile storage device such as a random access memory (RAM), and is used not only as a development area of a program or a work area of a function but also as a storage area in which information output by the operation of each block is temporarily recorded. A communication I/F 104 is an interface for performing information communication with an external device, and in the present embodiment, performs information communication with each ECU 301 and a communication unit of the power supply source 200 via the network 350.

In addition to the program executed by the control unit 101, the storage device 102 includes an outlet DB 110 that manages various types of information (outlet information) related to the outlet 302 belonging to the power supply system. In order to simplify the description, it is assumed that the management device 100 of the present embodiment sequentially receives information regarding a status of power supply from each ECU 301 to each outlet 302, and updates the managed outlet information.

### <Outlet Information>

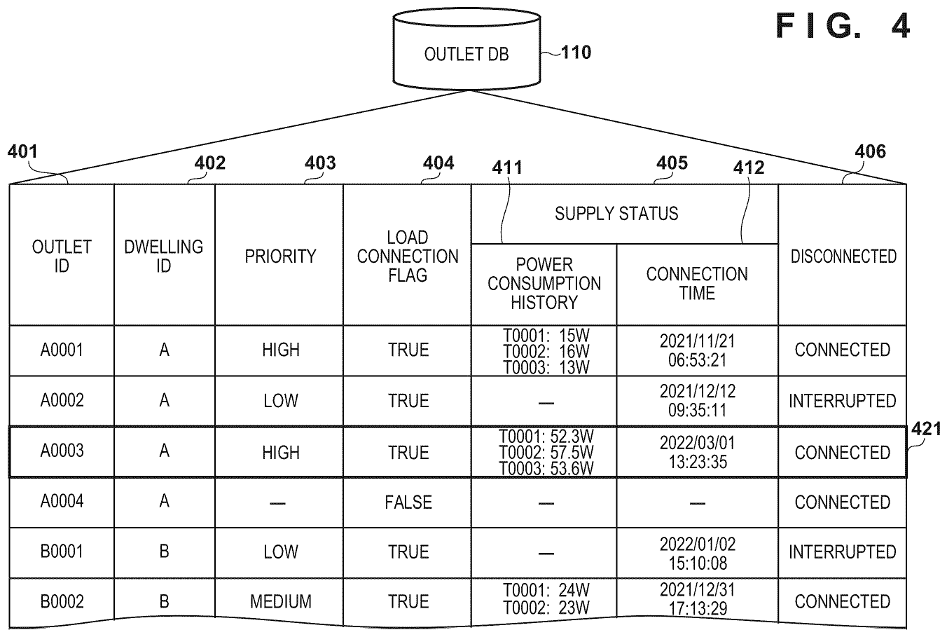

For example, as illustrated in FIG. 4, the outlet information managed for each outlet 302 in the outlet DB 110 is configured such that each record includes an outlet ID 401, a dwelling ID 402, a priority 403, a load connection flag 404, a supply status 405, and an interruption state 406.

Here, the outlet ID 401 is identification information that uniquely specifies the outlet 302 belonging to the power supply system. In addition, the dwelling ID 402 is identification information for uniquely specifying the dwelling 300 in which the outlet 302 is provided. The priority 403 is information indicating a power supply priority set for the outlet 302 in the entire power supply system. Although details will be described later, in the power supply system of the present embodiment, the demander can set the priority for the outlet 302 by mounting an IC tag around a plug of the load and inserting the plug into the outlet 302. Information regarding the priority related to the outlet 302 may be acquired, for example, when the load is connected to the outlet 302, and transmitted to the management device 100.

The load connection flag 404 is information indicating whether or not a load is connected to the corresponding outlet 302. The load connection flag 404 may be, for example, logical type information, and “True” indicates that a load is connected, and “False” indicates that no load is connected. Whether or not a load is connected is determined and managed based on, for example, a detection result received by the management device 100, the detection result being obtained when the ECU 301 detects that a plug related to the load is inserted into the outlet 302 and a conductive state is enabled or when the ECU 301 detects that the plug is removed and the conductive state is disabled.

The supply status 405 indicates various types of information indicating a power supply status for the load connected to the corresponding outlet 302. In the present embodiment, the supply status 405 includes, for a plurality of timings including the latest information acquisition timing, a power consumption history 411 indicating power consumption by the connected load and a connection time 412 indicating a timing at which the load is connected. The power consumption history 411 may be configured to be able to hold a history in the latest predetermined time such as 24 hours or one week.

The interruption state 406 indicates a state as to whether or not power is supplied to the corresponding outlet 302. Although details will be described later, in a situation where the power consumption of the entire power supply system is larger than power supplied from the power supply source 200 to the power supply system, a supply voltage decreases, and all the connected loads can stop. Therefore, in the power supply system of the present embodiment, an interrupter is provided on the power line connected to the outlet 302, and control is performed to appropriately cut off power supply to some of the outlets 302 to prevent power supply shortage.

For example, a record 421 illustrated in FIG. 4 indicates the outlet information regarding the outlet 302 provided in the dwelling 300 of which the dwelling ID 402 is “A”, the outlet 302 being identified by the outlet ID 401 of “A0003” in the power supply system. Information of the priority 403 and the interruption state 406 indicates that a priority of “high” is set for the outlet 302, and power can be currently supplied via the power line. Further, information of the load connection flag 404 indicates that a load is currently connected to the outlet 302. Further, it is possible to grasp that the load is connected at 13:23:35 on Mar. 1, 2022 and grasp a power consumption history in the latest predetermined time from information of the supply status 405.

### <Hardware Configuration of Dwelling 300>

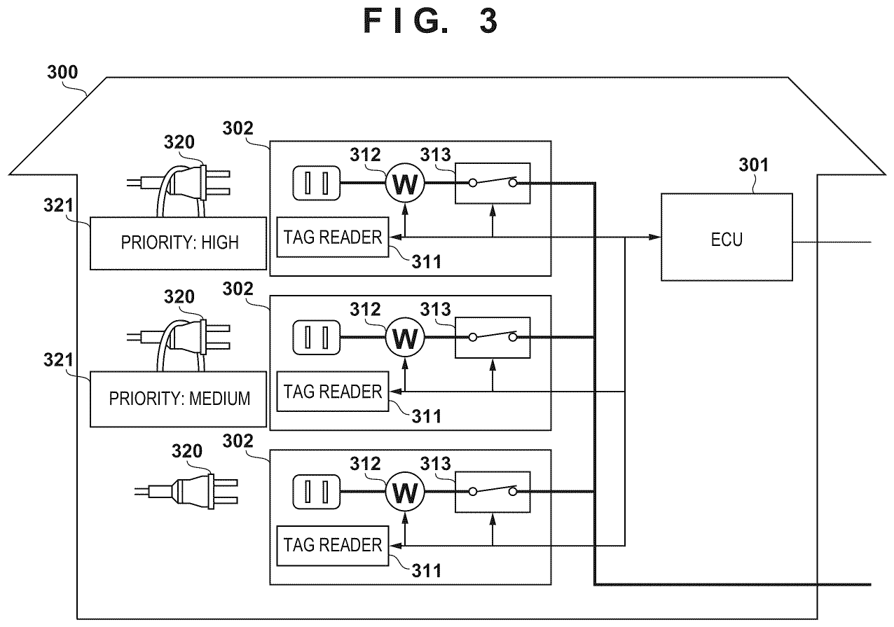

Next, a hardware configuration introduced into each dwelling 300 of the present embodiment will be described with reference to a block diagram of FIG. 3. The ECU 301 is hardware incorporating a CPU, a ROM, a RAM, and a communication I/F, and performs various controls related to one or more outlets 302 provided in one dwelling 300 based on information received from the management device 100. The ECU 301 also transmits and receives information to and from the management device 100. As illustrated, each of the outlets 302 includes a tag reader 311, a power meter 312, and an interrupter 313.

In the power supply system of the present embodiment, the demander can arbitrarily set the priority of the outlet 302 by mounting the IC tag to the plug of the load connected to the outlet 302. The IC tag is configured to incorporate a storage medium to which priority identification information is assigned. In the following description, in order to facilitate understanding of the invention, two types of usable IC tags, “high (highest priority)” and “medium (second highest priority)”, are issued. Therefore, each demander can assign three levels of priority of high, medium, and low to the outlet 302 to which the load is connected in three aspects of (1) attaching the high IC tag to the plug of the load, (2) attaching the medium IC tag to the plug of the load, and (3) not attaching any tag to the load plug. The IC tag may be, for example, issued by a provider of the power supply system or the power supply source 200 and distributed to each demander. Alternatively, the IC tag may be appropriately distributed in response to a request from the demander.

In a case where the load is connected to the outlet 302, that is, in a case where the plug 320 of the load is inserted, the tag reader 311 acquires information from the IC tag 321 mounted on the plug 320. That is, the tag reader 311 acquires the priority identification information from the storage medium of the IC tag 321 mounted on the plug 320 by, for example, near field communication. When the priority identification information is acquired, the tag reader 311 associates the outlet ID of the outlet 302 with the priority identification information, for example, and transmits the information to the ECU 301. When the priority identification information is received from the tag reader 311, the ECU 301 transmits the information to the management device 100 in association with the corresponding outlet ID. Then, the control unit 101 updates the priority 403 of the corresponding outlet information based on the received information, whereby the setting of the priority related to the corresponding outlet 302 is implemented. At this time, the control unit 101 may update the connection time 412 of the outlet information based on a reception time of the information.

The power meter 312 intermittently measures power (power consumed by the load) supplied to the load connected to the outlet 302. When the measurement result is obtained, the power meter 312 transmits the measurement result to the ECU 301 in association with, for example, the outlet ID of the corresponding outlet 302. When the measurement result is received from the power meter 312, the ECU 301 transmits the measurement result to the management device 100 in association with the outlet ID. Then, the control unit 101 updates the power consumption history 411 of the corresponding outlet information based on the received measurement result.

The interrupter 313 is configured to switch an interruption state of an electric path to the outlet 302. The interrupter 313 can switch between a connection state in which power is supplied to the load connected to the outlet 302 and a disconnection state in which power is not supplied to the load. A state change (interruption) by the interrupter 313 is controlled by the ECU 301.

### <<Outline of Interruption Control>>

Hereinafter, an outline of the interruption control for interruption switching of the power supply to each outlet 302 in the power supply system of the present embodiment will be described.

In the power supply system of the present embodiment, the control unit 101 monitors the power supply status of the entire system and determines whether or not to cut off the power supply to some outlets 302. As described above, the information regarding the supplied power from the power supply source 200 and the information regarding the power supply status related to the outlet 302 (hereinafter, referred to as a used outlet) to which the load is connected from the ECU 301 of each dwelling 300 are aggregated in the management device 100. First, the control unit 101 adds up the power consumption of all the used outlets at predetermined time intervals, thereby deriving the power consumption (hereinafter, referred to as total power consumption) of the entire power supply system at that time. More specifically, the control unit 101 specifies information in which the load connection flag 404 is true among pieces of outlet information managed by the outlet DB 110, and sums up the power consumption of the latest information acquisition timing included in the power consumption history 411 of the information to derive the total power consumption. Then, the control unit 101 determines whether or not it is now in a supply shortage state based on a difference between the derived total power consumption and the supplied power.

Here, the supply shortage state may include a state where the total power consumption exceeds the supplied power and the supply shortage actually occurs and a state where the supply shortage does not actually occur but the supply shortage is expected. The state in which the supply shortage actually occurs includes a state where the total power consumption exceeds the supplied power due to an increase in total power consumption and a state where the supplied power falls below the total power consumption due to a decrease in supplied power. In addition, the state in which the supply shortage is expected may be determined based on a predetermined condition that, for example, a value obtained by subtracting the supplied power from the total power consumption (total power consumption-supply power) is below a threshold, or the supply shortage is estimated to occur within a predetermined time based on the history of the total power consumption and the supplied power.

In a case where the control unit 101 determines that it is now in the supply shortage state, the control unit 101 determines an outlet with a low priority from among the used outlets as an outlet for which the corresponding interrupter 313 is to be switched to the disconnection state, that is, an outlet for which the power supply to the load is to be cut off (hereinafter, referred to as a disconnection outlet). Specifically, upon entering the supply shortage state, the control unit 101 specifies one outlet for which the lowest priority is set at that time among the used outlets, and determines the outlet as the disconnection outlet. Then, the control unit 101 transmits a command configured to switch the interrupter 313 related to the determined disconnection outlet to the disconnection state to the ECU 301 of the dwelling 300 in which the disconnection outlet is provided. When the command is received, the ECU 301 performs control to switch the state of the corresponding interrupter 313 to the disconnection state. As a result, upon entering the supply shortage state, the power line to the outlet 302 having the lowest priority for the demander at that time is in the disconnection state, so that the power supply status can be recovered by the amount of power consumed by the load connected to the outlet.

By the way, in an aspect in which three levels of priority can be set for the outlet 302 as in the present embodiment, the same priority can be set for a plurality of outlets. Such a case includes a case where different dwellings 300 use the IC tags 321 having the same priority for the loads, a case where the same demander uses the IC tags 321 having the same priority for a plurality of loads, or both cases. Therefore, in a case where the control unit 101 attempts to determine the disconnection outlet, there may be a plurality of outlets having the lowest priority.

At this time, it is also possible to recover the power supply status by determining all of the outlets having the lowest priority as the disconnection outlets, but there is a possibility that favorable power use by the demander will be hindered depending on the number of outlets. In addition, in a situation where the outlets having the medium and low priorities are already in the disconnection state, if all the used outlets having the high priority are switched to the disconnection state, the power supply is not allowed for any outlet, and thus, it is not possible to satisfy a power demand of the demander. Thus, the control unit 101 first determines whether or not the number of used outlets for which the priority is set is plural after specifying the priority (the lowest priority among the priorities of the used outlets) of selecting the disconnection outlet in the supply shortage state. Then, in a case where there are a plurality of used outlets for which the priority is set, the control unit 101 determines which one of the plurality of used outlets (hereinafter, referred to as a disconnection candidate outlet) is to be the disconnection outlet based on the supply status of each of the disconnection candidate outlets. In the present embodiment, the control unit 101 evaluates the supply status from the following three viewpoints.

The first viewpoint is an increment of the total power consumption in the latest predetermined time. In a case where the load fails, an irregular increase in power consumption of the load may be confirmed. There is a possibility that such a load will not operate in a preferable aspect even if power is supplied, and an effect corresponding to a charged power usage fee is not provided to the demander. Therefore, the control unit 101 determines whether or not the latest power consumption indicates a value exceeding a threshold for the maximum value of the power consumption in the latest predetermined time not including the latest power consumption by referring to the power consumption history 411 of the outlet information. That is, the control unit 101 determines whether or not the increment of the latest power consumption from the latest maximum power consumption exceeds the threshold. Here, the threshold may be determined according to the value of the power consumption of the load, for example, 50% of the maximum value of the latest power consumption. In a case where the increment of the latest power consumption from the latest maximum power consumption exceeds the threshold, the control unit 101 determines that the load connected to the outlet has failed and can determine the outlet as the disconnection outlet.

The second viewpoint is a timing at which the load is connected. In a case where the power supply system that was not in the supply shortage state becomes in the supply shortage state, it can be considered that the supply shortage is caused by the most recently connected load. In the power supply system such as the off-grid power supply system, a specification of the power supply source 200 is generally determined in advance in consideration of the power demand of the demander, and it is difficult to consider that the supply shortage state will be reached if the power demand does not change from the initial state. Therefore, in a case where the power supply system becomes in the supply shortage state, it is conceivable that some demanders newly add a load and use power different from the assumption. Therefore, the control unit 101 can determine an outlet to which the load is connected at the latest timing as the disconnection outlet at the time of entering the supply shortage state.

The third viewpoint is a magnitude of the power consumption of the load. There is a high possibility that the supply shortage state will be resolved by cutting off the power supply to the load whose power consumption is the largest. Therefore, the control unit 101 can determine an outlet with high power consumption of the connected load as the disconnection outlet.

Since the viewpoints all evaluate the supply status based on different criteria to determine the disconnection outlet, the control unit 101 gives priority to the viewpoints and selects the disconnection outlet from the disconnection candidate outlets. Specifically, the control unit 101 determines the disconnection outlet from among the plurality of disconnection candidate outlets in the priority order of an outlet in which the increment of the power consumption of the load in the latest predetermined time exceeds the threshold, an outlet in which the timing at which the load is connected is late, and an outlet in which the power consumption of the load is large. For example, the control unit 101 first determines whether or not there is a disconnection candidate outlet whose power consumption is rapidly increasing based on the first viewpoint, and if there is such a disconnection candidate outlet, determines the outlet as the disconnection outlet. If there is no disconnection candidate outlet corresponding to the first viewpoint, the control unit 101 determines an outlet connected at the latest timing as the disconnection outlet based on the second viewpoint. At this time, in a case where there are a plurality of outlets connected at the latest timing, the control unit 101 determines an outlet in which the power consumption of the connected load is the largest among the outlets as the disconnection outlet.

The determination of the disconnection outlet and the control for switching the corresponding interrupter 313 to the disconnection state based on the determination are repeated until the supply shortage state is resolved. That is, the control unit 101 transmits a command to the ECU 301 of the dwelling 300 in which the determined disconnection outlet is provided to switch the interrupter 313 related to the outlet to the disconnection state, and then compares the total power consumption and the supplied power again to determine whether or not the supply shortage state is resolved. Then, in a case where the supply shortage state is not resolved, that is, in a case where it is still in the supply shortage state, the control unit 101 determines the next disconnection outlet and performs interruption control of the corresponding interrupter 313 again, and in a case where the supply shortage state is resolved, the interruption state of the power line to each outlet 302 is maintained, and the operation is continued. In addition, it is sufficient if the interruption state of the interrupter 313 controlled to be switched to the disconnection state is sequentially switched to the connection state from the outlet with a high priority, for example, in a case where a predetermined time elapses in a state where the supply shortage state is resolved and a difference between the supplied power and the total power consumption becomes a predetermined value or more.

With such interruption control, in a case where the power supply system becomes in the supply shortage state, it is possible to cut off the power supply to the outlet 302 to which the load that hinders the stable operation is connected while reflecting the demand of the demander, thereby implementing suitable power supply.

### <<Interruption Control Processing>>

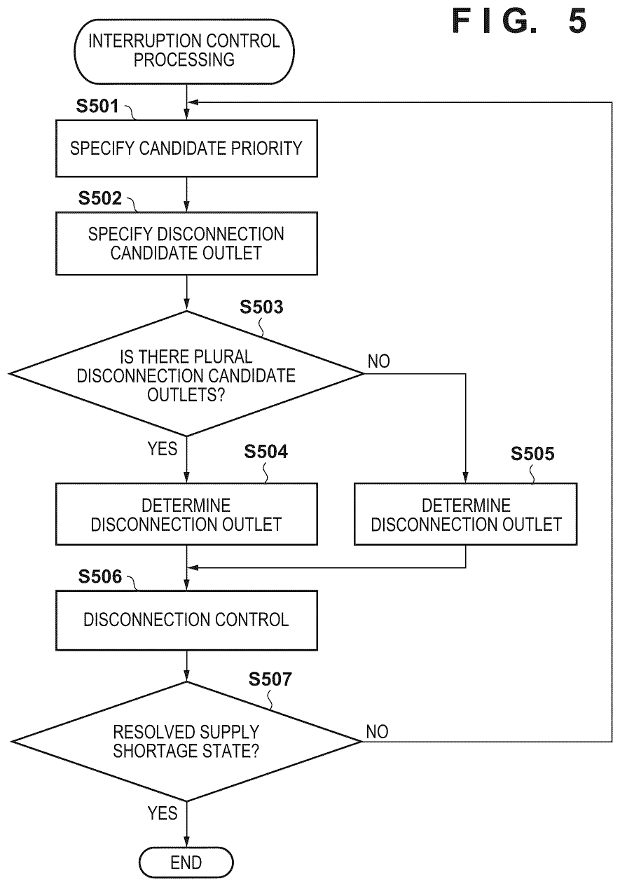

Hereinafter, specific interruption control processing executed when reaching the supply shortage state in the management device 100 of the present embodiment will be described with reference to the flowchart of FIG. 5. The processing corresponding to the flowchart can be implemented by the control unit 101, for example, reading a corresponding processing program recorded in the storage device 102, developing the processing program in the memory 103, and executing the processing program. The interruption control processing will be described as being started in a case where the control unit 101 determines that it is in the supply shortage state based on the difference between the total power consumption and the supplied power.

In S501, the control unit 101 specifies a priority (candidate priority) for selecting the disconnection outlet based on the priority set for each of the used outlets. Specifically, the control unit 101 determines the priorities of all the used outlets based on the outlet information, and specifies, as the candidate priority, the lowest priority at that time among the used outlets.

In S502, the control unit 101 specifies, as the disconnection candidate outlet, an outlet of which the set priority is the candidate priority among the used outlets.

In S503, the control unit 101 determines whether or not there are a plurality of disconnection candidate outlets. In a case where the control unit 101 determines that there are a plurality of disconnection candidate outlets, the processing proceeds to S504, and in a case where the control unit 101 determines that there is a single disconnection candidate outlet, the processing proceeds to S505.

In S504, the control unit 101 determines the disconnection outlet by referring to the supply status 405 of the outlet information of each of the disconnection candidate outlets.

On the other hand, in a case where it is determined that there is a single disconnection candidate outlet in S503, the control unit 101 determines the disconnection candidate outlet as the disconnection outlet in S505.

In S506, the control unit 101 transmits a disconnection command including the outlet ID of the disconnection outlet to the ECU 301 of the dwelling 300 in which the determined disconnection outlet is provided, and performs control to switch the corresponding interrupter 313 to the disconnection state.

In S507, the control unit 101 determines whether or not the supply shortage state is resolved based on the difference between the total power consumption and the supplied power, the difference being changed in response to the interruption by the processing of S506. The control unit 101 completes the interruption control processing in a case where it is determined that the supply shortage state is resolved, and returns the processing to S501 in a case where it is determined that the supply shortage state is not resolved.

In this way, with the management device of the present embodiment, it is possible to implement stable power supply while reflecting the demand of the demander in the power supply system having a restriction on supplied power. More specifically, in a state where the supplied power is insufficient for the power consumption in the power supply system, the management device can reduce the power consumption while stably maintaining the power supply to the load connected to the outlet having a high priority. In addition, the management device can determine the outlet for which the power supply is to be cut off in the supply shortage state by reflecting the priority assumed by the demander. In addition, in a case where there are a plurality of outlets having the same priority, the management device can perform valid interruption control reflecting the supply status, and can implement power distribution ensuring fairness between the demanders while dealing with irregularly occurring factors of the supply shortage state. In addition, the management device can operate so as to limit the power consumption in a state where the supply shortage actually occurs or a state where the supply shortage is expected while allowing free power consumption of the demander in a state where the supply is sufficient. In addition, in a case where it becomes in the supply shortage state, the power distribution is performed within a limited supply capacity range without increasing a power generation amount of the power supply source 200 or requiring investment to expand the scale, and thus, it is possible to implement suitable power supply while reducing an influence on the environment.

The priority may be referred to, for example, in the calculation of the power usage fee, and the higher the priority of the IC tag 321 attached to the plug 320, the higher the power usage fee. That is, by mounting the IC tag 321 with a high priority on the plug 320 of the load, the demander can preferentially supply power to the load even in a case where it becomes in the supply shortage state, but in return, a higher power usage fee is charged than in a case of using the IC tag 321 with lower priority. On the other hand, by mounting the IC tag 321 with a low priority on the plug 320 of the load or not mounting any IC tag, the demander can easily cut off the power supply to the load in a case where it becomes in the supply shortage state, but the charged power usage fee can be reduced as compared with a case of using the IC tag 321 with a higher priority. In this way, fairness between the demanders may be implemented.

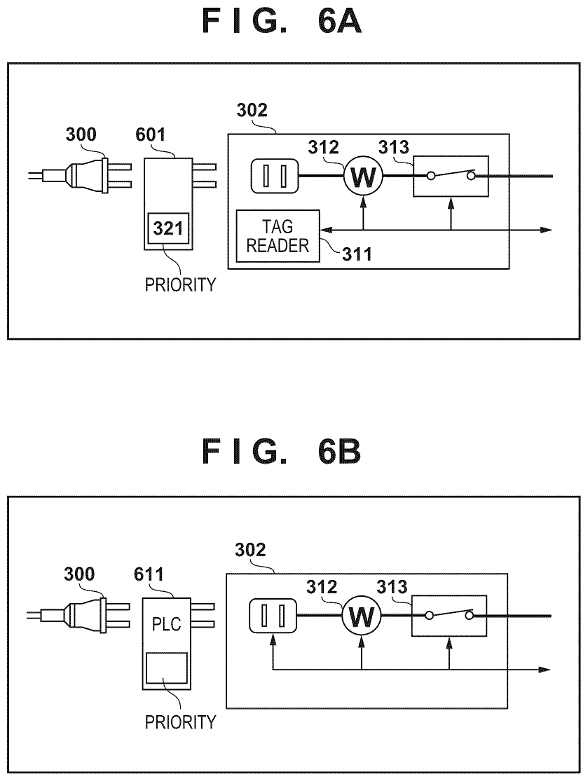

Furthermore, in the present embodiment, the IC tag 321 has been described as being mounted on the periphery of the plug 320 of the load as illustrated in FIG. 3, but the implementation of the present invention is not limited thereto. For example, the IC tag 321 may be embedded in a plug unit 601 into which the plug 320 can be inserted as illustrated in FIG. 6A. In addition, the setting of the priority for the outlet 302 is not limited to the method in which the tag reader 311 reads the IC tag 321, and for example, the identification information of the priority may be directly transmitted from a plug unit 611 having a power line communication (PLC) function as illustrated in FIG. 6B to the ECU 301.

### [First Modification]

In the embodiment described above, in a case where there are a plurality of disconnection candidate outlets, the supply statuses thereof are evaluated from three viewpoints, and the disconnection outlet is determined based on the priority order of the evaluation. However, the implementation of the present invention is not limited thereto. The supply statuses do not have to be evaluated in a complex manner from three viewpoints, but may be evaluated from only one of the viewpoints.

For example, the control unit 101 may determine, as the disconnection outlet, at least the outlet in which the increment of the power consumption of the load in the latest predetermined time exceeds the threshold among the disconnection candidate outlets. At this time, in a case where there is no disconnection candidate outlet corresponding to the condition, the control unit 101 may sequentially lower the threshold so that the disconnection outlet can be determined. As a result, at least the outlet 302 connected to the load suspected of a failure or the like can be preferentially set as a power supply cutoff target.

In addition, for example, the control unit 101 may determine, as the disconnection outlet, at least the outlet to which the load is connected at the latest timing among the disconnection candidate outlets. As a result, it is possible to determine whether the supply shortage state is resolved after returning to the previous power supply state, which had not yet reached at least the supply shortage state.

Furthermore, for example, the control unit 101 may determine, as the disconnection outlet, at least the outlet in which the power consumption of the load is the largest among the disconnection candidate outlets. As a result, it is possible to implement fair power distribution with limited supplied power.

### [Second Modification]

In the embodiment described above, an aspect in which the three viewpoints for evaluating the supply status and the priority order thereof are determined in advance has been described for a method of determining the disconnection outlet in a case where there are a plurality of disconnection candidate outlets, but the implementation of the present invention is not limited thereto. The method of evaluating the supply status and information regarding the priority order of evaluation when determining the disconnection outlet based on the evaluation may be arbitrarily settable by a designer, a provider, or the like of the power supply system. In this aspect, the control unit 101 receives setting of a disconnection priority condition based on the supply status from the designer or the like and stores the setting in the storage device 102, for example, and can refer to the setting in a case where there are a plurality of disconnection candidate outlets in the supply shortage state.

As a result, it is possible to implement power supply based on a disconnection rule at the time of supply shortage reflecting a power demand circumstance in an area where the power supply system is introduced and a demand tendency of the demander.

### Second Embodiment

In the embodiment and the modifications described above, an aspect in which the demander sets the priority of the outlet 302 by mounting the desired IC tag 321 to the plug 320 of the load to be connected has been described, but the implementation of the present invention is not limited thereto. The implementation of the present invention only needs to be able to identify the outlet 302 to which a load with a high priority for the demander is connected, and for example, the priority may be set in advance for the outlet 302 at the time of introduction to each dwelling 300. That is, the outlets 302 of all types of priority may be introduced into each dwelling 300, and each demander may be able to adjust a priority of power supply to the load depending on to which outlet 302 the load is connected. In other words, in the aspect of the present embodiment, each demander does not need to obtain the IC tag 321 corresponding to a desired priority for each load and mount the IC tag 321 to the plug 320, and can arbitrarily adjust the priority of power supply to the load by changing the outlet 302 to which the load is to be connected.

Information indicating which priority is set for the outlet 302 is stored in, for example, the storage device 102 or the ECU 301 of each dwelling 300 as setting information, and it is sufficient if the control unit 101 reflects the setting information in the outlet information of the outlet DB 110 at an arbitrary timing. Since the required number of outlets 302 of each type can vary depending on the demand of the demander, the setting information may be changeable at any timing. In this way, it can be considered that the priority setting is approved by the demander at the time of connecting the load, and thus, it is possible to perform suitable power supply reflecting the demand of the demander in the supply shortage state as in the first embodiment.

### Third Embodiment

In the embodiments and the modifications described above, when the control unit 101 determines the disconnection outlet, the corresponding interrupter 313 is forcibly switched to the disconnection state. Therefore, there is a possibility that the operation of the load connected to the outlet will stop against the intention of the demander. For example, in a case where the priorities of all the used outlets are high at the time it became the supply shortage state, one of the used outlets is determined as the disconnection outlet, and the corresponding interrupter 313 is controlled to be switched to the disconnection state. That is, it is severe because the power supply is cut off although the demander who has connected the load to the disconnection outlet uses the outlet to which the load is connected in such a way that the priority is set to be high.

Therefore, in the power supply system of the present embodiment, in a case where the disconnection outlet is determined, the control unit 101 notifies the demander who uses the dwelling 300 in which the outlet is provided of information for specifying the disconnection outlet before transmitting the disconnection command for the corresponding interrupter 313 to the corresponding ECU 301. That is, in order to resolve the supply shortage state, information indicating whether the power supply is cut off or which outlet is to be disconnection is notified in advance.

Here, the notification may be performed using, for example, a mobile terminal used by the demander or a notification speaker provided in the dwelling 300. In addition, for example, a demander DB that manages information of each demander using the power supply system may be provided in the storage device 102, and information regarding a transmission destination of the notification, that is, a contact related to the demander may be included the demander DB.

In this way, it is possible to allow a grace period until the demander brings the corresponding load into a state where the power supply may be cut off in response to the notified cut off of the power supply. Alternatively, the notification can be expected to prompt a voluntary action of the demander, such as removing a load connected to the corresponding outlet 302 or removing a load connected to another outlet 302 for which the same priority is set so as not to cut off the power supply to the load. Therefore, with the management device of the present embodiment, it is possible to perform interruption control in consideration of the demander in a case where becomes in the supply shortage state.

Since there is a possibility that the demander will feel annoyed by performing such notification for all the outlets 302, the notification may be performed in a case where an outlet for which a specific priority is set is determined as the disconnection outlet, for example, the notification may be performed only for the outlet 302 with a high priority.

### [Third Modification]

In the embodiments and the modifications described above, it has been described that the control for switching the interruption state of the interrupter 313 for the disconnection outlet determined by the management device 100 is performed via the ECU 301, but the implementation of the present invention is not limited thereto. The present invention is also applicable to an aspect in which the ECU 301 is not provided in each dwelling 300, and the control unit 101 collects information regarding each outlet 302 and directly performs control to switch the interruption state of the interrupter 313.

In addition, in the embodiments and the modifications described above, it has been described that the power supply system supplies power from the power supply source 200 to the plurality of dwellings 300, but it goes without saying that the present invention is applicable to any scale unit such as one dwelling 300. For example, in an aspect in which power supplied from the power supply source 200 to one dwelling 300 is distributed to a plurality of outlets 302 provided in the dwelling 300 for use, the present invention can be applied to interruption control for resolving supply shortage state in the dwelling 300.

### [Fourth Modification]

In the embodiments and the modifications described above, an aspect in which the present invention is applied to the off-grid power supply system has been described. However, the implementation of the present invention is not limited thereto, and the present invention can also be implemented, for example, in a power supply system or a power supply system configured to be able to cooperate with a microgrid or a grid.

### Summary of Embodiments

The embodiments described above disclose at least the following management device, management method, storage medium, and program.

1. A management device of the embodiments described above wherein:

a management device configured to control an interruption unit provided between a power supply source and each of a plurality of outlets, the management device comprising:

a monitoring unit configured to determine whether or not it is in a supply shortage state based on a difference between supplied power from the power supply source and power consumption of at least one load connected to each of the plurality of outlets;

a determination unit (S502) configured to determine priorities of the plurality of outlets; and

a control unit (S504, S505, S506) configured to switch the interruption unit associated with an outlet having a low priority based on a determination result of the determination unit to a disconnection state in a case where the monitoring unit determines that it is in the supply shortage state.

According to the embodiment, in a state where the supplied power is insufficient for the power consumption in the power supply system, it is possible to reduce the power consumption while stably maintaining the power supply to the load connected to the outlet having a high priority.

2. A management device of the embodiments described above wherein:

each of the plurality of outlets includes an acquisition unit configured to acquire priority identification information from a storage medium to which the priority identification information is assigned when the at least one load is connected, and

the determination unit (S502) determines the priority of the outlet for each of the plurality of outlets based on the priority identification information acquired by the acquisition unit.

According to the embodiment, it is possible to determine the outlet for which the power supply is to be cut off when the supply shortage occurs by reflecting the priority assumed by the demander.

3. A management device of the embodiments described above wherein:

the determination unit (S504) determines the priorities of the plurality of outlets based on setting information in which the priority of each of the plurality of outlets is set in advance.

According to the embodiment, since the outlets to which the priorities are assigned in advance are provided to the demander, it is possible to determine the outlet for which the power supply is to be cut off when the supply shortage occurs under the assumption that the priority setting is approved at the time of connecting the load.

4. A management device of the embodiments described above further comprising

an acquisition unit configured to acquire a supply status of each of the plurality of outlets, wherein

in a case where there are a plurality of outlets having the same priority, the control unit determines an outlet for which the interruption unit is to be switched to the disconnection state based on the supply status of each of the plurality of outlets.

According to the embodiment, it is possible to perform valid interruption control reflecting the supply status in a case where the outlet for which the power supply is to be cut off is determined from among the plurality of outlets having the same priority.

5. A management device of the embodiments described above wherein:

the supply status includes a history of the power consumption of the at least one load connected to each of the plurality of outlets, and

in a case where there are a plurality of outlets having the same priority, the control unit determines at least an outlet in which an increment of the power consumption of the at least one load in a latest predetermined time exceeds a threshold among the plurality of outlets as the outlet for which the interruption unit is to be switched to the disconnection state.

According to the embodiment, the outlet connected to the load suspected of a failure or the like can be preferentially set as a power supply cutoff target.

6. A management device of the embodiments described above wherein:

the supply status includes information regarding a timing at which the at least one load was connected to each of the plurality of outlets, and in a case where there are a plurality of outlets having the same priority, the control unit determines at least an outlet in which a timing at which the at least one load is connected was latest among the plurality of outlets as the outlet for which the interruption unit is to be switched to the disconnection state.

According to the embodiment, it is possible to determine whether the supply shortage is resolved after returning to the previous power supply state in which at least the supply shortage does not occur.

7. A management device of the embodiments described above wherein:

the supply status includes the power consumption of the at least one load connected to each of the plurality of outlets, and

in a case where there are a plurality of outlets having the same priority, the control unit determines at least an outlet in which the power consumption of the at least one load is largest among the plurality of outlets as the outlet for which the interruption unit is to be switched to the disconnection state.

According to the embodiment, it is possible to implement fair power distribution with limited supplied power.

8. A management device of the embodiments described above wherein:

the supply status includes a history of the power consumption of the at least one load connected to each of the plurality of outlets and information regarding a timing at which the at least one load is connected to each of the plurality of outlets, and

in a case where there are a plurality of outlets having the same priority, the control unit (S504) determines the outlet for which the interruption unit is to be switched to the disconnection state from among the plurality of outlets in a priority order of an outlet in which an increment of the power consumption of the at least one load in a latest predetermined time exceeds a threshold, an outlet in which a timing at which the at least one load is connected is latest, and an outlet in which the power consumption of the at least one load is largest.

According to the embodiment, it is possible to implement power distribution ensuring fairness between the demanders while dealing with a factor of the supply shortage that irregularly occurs.

9. A management device of the embodiments described above further comprising

an input unit configured to receive setting of a disconnection priority condition based on the supply status when there are a plurality of outlets having the same priority, wherein

in a case where there are a plurality of outlets having the same priority, the control unit determines the outlet for which the interruption unit is to be switched to the disconnection state based on the supply status of each of the plurality of outlets and the disconnection priority condition.

According to the embodiment, it is possible to perform power supply control reflecting a disconnection rule at the time of supply shortage determined by a designer or the like of the power supply system.

10. A management device of the embodiments described above wherein:

the control unit (S504) repeats control to switch the interruption unit associated with the outlet to the disconnection state until the monitoring unit determines that it is not in the supply shortage state.

According to the embodiment, it is possible to implement suitable power distribution that enables stable operation while interrupting the power supply to the outlet in stages.

11. A management device of the embodiments described above wherein:

the power supply source and the plurality of outlets belong to an off-grid power supply system or a microgrid power supply system.

According to the embodiment, it is possible to implement suitable power supply according to an aspect of the power supply source under an environment where the supplied power is limited.

12. A management device of the embodiments described above wherein:

the plurality of outlets are provided in a plurality of demanders, and

the management device further comprises a transmission unit configured to transmit information for specifying the outlet to a contact related to the demander who uses the outlet before disconnection in a case where it is determined to switch the interruption unit associated with the outlet to the disconnection state.

According to the embodiment, it can be expected that the power supply to the load is not forcibly cut off, and a corresponding demander is prompted to release connection of the load by himself/herself.

13. A management device of the embodiments described above wherein:

the supply shortage state is a state where the power consumption increases and exceeds the supplied power or a state where the supplied power decreases and falls below the power consumption, or a predetermined state where the supply shortage is expected.

According to the embodiment, it is possible to perform operation so as to limit the power consumption in a state where the supply shortage actually occurs or a state where the supply shortage is expected while allowing free power consumption of the demander in a state where the supply is sufficient.

14. A management method of the embodiments described above wherein:

a management method of controlling an interruption unit provided between a power supply source and each of a plurality of outlets, the management method being executed by a management device and comprising:
judging whether or not it is in a supply shortage state based on a difference between supplied power from the power supply source and power consumption of at least one load connected to each of the plurality of outlets;
determining (S502) priorities of the plurality of outlets; and
switching (S504, S505, S506) the interruption unit associated with an outlet having a low priority based on a determination result in the determining to a disconnection state in a case where it is judged in the judging that it is in the supply shortage state.

According to the embodiment, in a state where the supplied power is insufficient for the power consumption in the power supply system, it is possible to reduce the power consumption while stably maintaining the power supply to the load connected to the outlet having a high priority.

15. A storage medium of the embodiments described above is:

storing a program for causing a computer configured to control an interruption unit provided between a power supply source and each of a plurality of outlets to execute:
judging whether or not it is in a supply shortage state based on a difference between supplied power from the power supply source and power consumption of at least one load connected to each of the plurality of outlets;
determining (S502) priorities of the plurality of outlets; and
switching (S504, S505, S506) the interruption unit associated with an outlet having a low priority based on a determination result in the determining to a disconnection state in a case where it is judged to be in the supply shortage state in the judging.

According to the embodiment, in a state where the supplied power is insufficient for the power consumption in the power supply system, it is possible to reduce the power consumption while stably maintaining the power supply to the load connected to the outlet having a high priority.

16. A program of the embodiments described above is:

for causing a computer configured to control an interruption unit provided between a power supply source and each of a plurality of outlets to execute:
judging whether or not it is in a supply shortage state based on a difference between supplied power from the power supply source and power consumption of at least one load connected to each of the plurality of outlets;
determining (S502) priorities of the plurality of outlets; and
switching (S504, S505, S506) the interruption unit associated with an outlet having a low priority based on a determination result in the determining to a disconnection state in a case where it is judged to be in the supply shortage state in the judging.

According to the embodiment, in a state where the supplied power is insufficient for the power consumption in the power supply system, it is possible to reduce the power consumption while stably maintaining the power supply to the load connected to the outlet having a high priority.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A management device configured to control an interruption unit provided between a power supply source and each of a plurality of outlets, the management device comprising:
a monitoring unit configured to determine whether or not it is in a supply shortage state based on a difference between supplied power from the power supply source and power consumption of at least one load connected to each of the plurality of outlets;
a determination unit configured to determine priorities of the plurality of outlets; and
a control unit configured to switch the interruption unit associated with an outlet having a low priority based on a determination result of the determination unit to a disconnection state in a case where the monitoring unit determines that it is in the supply shortage state, wherein
each of the plurality of outlets includes a first acquisition unit configured to acquire priority identification information from a storage medium to which the priority identification information is assigned when the at least one load is connected, and
the determination unit determines the priority of the outlet for each of the plurality of outlets based on the priority identification information acquired by the first acquisition unit.

2. The management device according to claim 1, wherein
the determination unit determines the priorities of the plurality of outlets based on setting information in which the priority of each of the plurality of outlets is set in advance.

3. The management device according to claim 1, further comprising
a second acquisition unit configured to acquire a supply status of each of the plurality of outlets, wherein
in a case where there are a plurality of outlets having the same priority, the control unit determines an outlet for which the interruption unit is to be switched to the disconnection state based on the supply status of each of the plurality of outlets.

4. The management device according to claim 3, wherein
the supply status includes a history of the power consumption of the at least one load connected to each of the plurality of outlets, and
in a case where there are a plurality of outlets having the same priority, the control unit determines at least an outlet in which an increment of the power consumption of the at least one load in a latest predetermined time exceeds a threshold among the plurality of outlets as the outlet for which the interruption unit is to be switched to the disconnection state.

5. The management device according to claim 3, wherein
the supply status includes information regarding a timing at which the at least one load was connected to each of the plurality of outlets, and
in a case where there are a plurality of outlets having the same priority, the control unit determines at least an outlet in which a timing at which the at least one load was connected is latest among the plurality of outlets as the outlet for which the interruption unit is to be switched to the disconnection state.

6. The management device according to claim 3, wherein
the supply status includes the power consumption of the at least one load connected to each of the plurality of outlets, and
in a case where there are a plurality of outlets having the same priority, the control unit determines at least an outlet in which the power consumption of the at least one load is largest among the plurality of outlets as the outlet for which the interruption unit is to be switched to the disconnection state.

7. The management device according to claim 3, wherein
the supply status includes a history of the power consumption of the at least one load connected to each of the plurality of outlets and information regarding a timing at which the at least one load is connected to each of the plurality of outlets, and
in a case where there are a plurality of outlets having the same priority, the control unit determines the outlet for which the interruption unit is to be switched to the disconnection state from among the plurality of outlets in a priority order of an outlet in which an increment of the power consumption of the at least one load in a latest predetermined time exceeds a threshold, an outlet in which a timing at which the at least one load is connected is latest, and an outlet in which the power consumption of the at least one load is largest.

8. The management device according to claim 3, further comprising
an input unit configured to receive setting of a disconnection priority condition based on the supply status when there are a plurality of outlets having the same priority, wherein
in a case where there are a plurality of outlets having the same priority, the control unit determines the outlet for which the interruption unit is to be switched to the disconnection state based on the supply status of each of the plurality of outlets and the disconnection priority condition.

9. The management device according to claim 1, wherein
the control unit repeats control to switch the interruption unit associated with the outlet to the disconnection state until the monitoring unit determines that it is not in the supply shortage state.

10. The management device according to claim 1, wherein
the power supply source and the plurality of outlets belong to an off-grid power supply system or a microgrid power supply system.

11. The management device according to claim 10, wherein
the plurality of outlets are provided in a plurality of demanders, and
the management device further comprises a transmission unit configured to transmit information for specifying the outlet to a contact related to the demander who uses the outlet before disconnection in a case where it is determined to switch the interruption unit associated with the outlet to the disconnection state.

12. The management device according to claim 1, wherein
the supply shortage state is a state where the power consumption increases and exceeds the supplied power, or a state where the supplied power decreases and falls below the power consumption, or a predetermined state where the supply shortage is expected.

13. A management method of controlling an interruption unit provided between a power supply source and each of a plurality of outlets, the management method being executed by a management device and comprising:
judging whether or not it is in a supply shortage state based on a difference between supplied power from the power supply source and power consumption of at least one load connected to each of the plurality of outlets;
determining priorities of the plurality of outlets; and
switching the interruption unit associated with an outlet having a low priority based on a determination result in the determining to a disconnection state in a case where it is judged to be in the supply shortage state in the judging, wherein
each of the plurality of outlets acquires priority identification information from a storage medium to which the priority identification information is assigned when the at least one load is connected, and
in the determination, the priority of the outlet is determined for each of the plurality of outlets based on the acquired priority identification information.

14. A computer-readable storage medium storing a program for causing a computer configured to control an interruption unit provided between a power supply source and each of a plurality of outlets to execute:
judging whether or not it is in a supply shortage state based on a difference between supplied power from the power supply source and power consumption of at least one load connected to each of the plurality of outlets;
determining priorities of the plurality of outlets; and
switching the interruption unit associated with an outlet having a low priority based on a determination result in the determining to a disconnection state in a case where it is judged to be in the supply shortage state in the judging, wherein
each of the plurality of outlets acquires priority identification information from a storage medium to which the priority identification information is assigned when the at least one load is connected, and
in the determination, the priority of the outlet is determined for each of the plurality of outlets based on the acquired priority identification information.
